(19) United States
(12) Patent Application Publication
(10) Pub. No.: US 2026/0185895 A1
(43) Pub. Date: Jul. 2, 2026

(54) HIGH-TEMPERATURE VIBRATION DEVICE SUITABLE FOR LARGE CARBON FIBER RESIN-BASED COMPOSITE COMPONENTS

(71) Applicant: NANJING UNIVERSITY OF AERONAUTICS AND ASTRONAUTICS, Nanjing (CN)

(72) Inventors: Jinghua ZHENG, Nanjing (CN); Zhongde SHAN, Nanjing (CN); Congze FAN, Nanjing (CN); Wenzhe SONG, Nanjing (CN); Yiwei CHEN, Nanjing (CN); Yufeng JIN, Nanjing (CN)

(73) Assignee: NANJING UNIVERSITY OF AERONAUTICS AND ASTRONAUTICS, Nanjing (CN)

(21) Appl. No.: 19/373,819

(22) Filed: Oct. 30, 2025

Related U.S. Application Data
(63) Continuation of application No. PCT/CN2025/071943, filed on Jan. 13, 2025.

(30) Foreign Application Priority Data
Dec. 27, 2024 (CN) 202411944532.0

(51) Int. Cl. G01M 9/04; C08J 5/04; G01M 17/00; G01M 99/00

(52) U.S. Cl. CPC G01M 9/04; C08J 5/042; G01M 99/002; G01M 17/00

(57) ABSTRACT

A high-temperature vibration device includes a large carbon fiber resin-based composite component, a variable diameter support device, an oxyacetylene flame gun, a threaded ejection rod, a support body, a base adapter plate, a laser vibrometer, a support frame, a vibration measuring port, a vent valve, a platinum rhodium thermocouple, and a vibration table. The large carbon fiber resin-based composite component is fixed to the support body for the vibration table, the oxyacetylene flame gun moves and extends to one end of the large carbon fiber resin-based composite component, and the variable diameter support device fixes the oxyacetylene flame gun inside the large carbon fiber resin-based composite component. The flame gun provides a high-temperature ablative thermal environment, the vibration table is fixedly connected to the support body to provide random vibration excitation, and the laser vibrometer passes through the high-temperature vibration box to collect vibration signals.

### CROSS REFERENCE TO THE RELATED APPLICATIONS

This application is a continuation application of International Application No. PCT/CN2025/071943, filed on Jan. 13, 2025, which is based upon and claims priority to Chinese Patent Application No. 202411944532.0, filed on Dec. 27, 2024, the entire contents of which are incorporated herein by reference.

### TECHNICAL FIELD

The present invention relates to the field of testing large carbon fiber resin-based composite components in aerospace flight environments, and in particular, to a high-temperature vibration device suitable for large carbon fiber resin-based composite components.

### BACKGROUND

Carbon fiber resin-based composites are widely used in the fields of aerospace, automotive industry, etc. due to their high strength, high modulus, lightweight, corrosion resistance, and excellent thermal stability.. Currently, large key components such as aircraft wings, tail fins, engine fan blades, rocket shells, and nozzles are all made of carbon fiber resin-based composites. With the rapid development of ultra-high-speed aircraft, the high-temperature vibration modal change rules of large carbon fiber resin-based composite components in extremely complex flight environments have become a research focus for more and more scholars. Especially for carbon fiber resin-based composites, extreme aerodynamic environments and high-temperature environments seriously affect the performance of carbon fiber resin-based composites, and uneven thermal stress incurs high-temperature modal changes in components, directly affecting the stability and safety of aircraft. Meanwhile, it is challenging to simulate real extreme high-temperature vibration flight environments of aircraft through ground modal testing. Therefore, it is urgent to build a high-temperature vibration device suitable for large carbon fiber resin-based composite components, which can accurately simulate real working conditions of a flight environment through a ground atmospheric environment, achieve accurate prediction of a high-temperature mode of large carbon fiber resin-based composite components, and guide and verify the design feasibility of aircraft in extreme flight environments.

Currently, the building of high-temperature vibration mode devices for carbon fiber resin-based composites employs radiation heating such as quartz lamps to form extreme high-temperature environments, but the uniformly heated environments cannot accurately simulate uneven ablation during the flight of aircraft. Meanwhile, due to the limitation of melting points of materials such as quartz, heating devices such as quartz lamps cannot provide stable high-temperature thermal environments above 1400° C. Moreover, in real flight environments, large carbon fiber resin-based composite components work in a micro oxygen environment, challenging ground atmospheric environment simulation. In addition, carbon fiber resin-based composites produce a large amount of gas in extreme high temperature environments. Such gas has an impact on vibration measurement and the physical health of experimental personnel. Therefore, a large number of researchers urgently need to build high-temperature vibration devices suitable for large carbon fiber resin-based composite components, to accurately simulate real working conditions of micro oxygen and uneven ablation in extreme flight environments of aircraft, provide a safe and reliable experimental environment for experimental workers, and achieve precise acquisition of high-temperature vibration modes of large carbon fiber resin-based composite components in aerospace flight environments.

### SUMMARY

To solve the above problems, the present invention discloses a high-temperature vibration device suitable for large carbon fiber resin-based composite components. The device can provide an uneven heating environment above 1200° C. and micro oxygen working conditions for large carbon fiber resin-based composite components, achieve accurate acquisition of high-temperature vibration modes of large carbon fiber resin-based composite components, and provide a safe and stable implementation environment for operators. The device provides experimental means for the stability and design feasibility of large carbon fiber resin-based composite components in aerospace flight environments.

A technical solution of the present invention is as follows: A high-temperature vibration device suitable for large carbon fiber resin-based composite components includes a large carbon fiber resin-based composite component, a variable diameter support device, an oxyacetylene flame gun, a threaded ejection rod, a support body, a base adapter plate, a sliding rail, a sliding truss I, a sliding truss II, a laser vibrometer, a support frame, a vibration measuring port, a vent valve, a platinum rhodium thermocouple, a vibration table, a high-temperature fire door, a high-temperature vibration box, a smoke absorber, a hollow shaft, high-temperature support sheet, and linkage connecting rods; high-temperature bolts pass through the base adapter plate to fix the support body to a top of the vibration table, the large carbon fiber resin-based composite component is nested in a conical fixture of the support body, the threaded ejection rod outside the conical fixture is rotated to stably fix the large carbon fiber resin-based composite component, and the vibration table applies random excitation signals to provide random vibration; the oxyacetylene flame gun is fixed to a right side of the high-temperature vibration box, the variable diameter support device is nested on an inner wall of the oxyacetylene flame gun, the oxyacetylene flame gun and the variable diameter support device are fixed on one side of the large carbon fiber resin-based composite component, the hollow shaft of the variable diameter support device is slid to drive the 8 linkage connecting rods to expand, the 8 high-temperature support sheets are expanded to an inner wall of the large carbon fiber resin-based composite component, the oxyacetylene flame gun jets flame, and the flame passes through the variable diameter support device to ablate the inner wall of the large carbon fiber resin-based composite component and provide a high-temperature ablation environment above 1200° C.; the smoke absorber on a left side of the high-temperature vibration box effectively absorbs smoke to provide a safe and stable experimental environment; laser from the laser vibrometer at a top of the high-temperature vibration box passes through the vibration measuring port and irradiates the large carbon fiber resin-based composite component, and high-temperature vibration modal data of the large carbon fiber resin-based composite component is collected to obtain high-temperature vibration modal parameters.

The present invention is suitable for high-temperature vibration testing of large carbon fiber resin-based composite components. The high-temperature bolts pass through the base adapter plate to connect the vibration table to the support body, and the support body is composed of a base, a support plate, reinforcing ribs, and a conical fixture, where the support plate is welded to a middle part of the base of the support body, the two reinforcing ribs are distributed on both sides of the support plate to provide stable support, the conical fixture is welded to an upper end of the support plate, threaded ejection rod holes are formed circumferentially every 60° on an outer wall of the conical fixture, and the large carbon fiber resin-based composite component is nested in the conical fixture. Without damaging the integrity of the large carbon fiber resin-based composite component, the threaded ejection rod is rotated, the large carbon fiber resin-based composite component is bonded with a high-temperature adhesive and stably fixed on an inner wall of the conical fixture, and the vibration table applies random excitation to transmit excitation signals to the large carbon fiber resin-based composite component.

The present invention is suitable for high-temperature ablation testing of large carbon fiber resin-based composite components. For large carbon fiber resin-based composite components with different diameters, replacing the flame jet diameter of the oxyacetylene flame gun to adapt to the large carbon fiber resin-based composite components is time-consuming and laborious and affects an experimental progress. The variable diameter support device described in the present invention is composed of a hollow shaft, linkage connecting rods, and high-temperature support sheets, where the hollow shaft is nested on the outer wall of the oxyacetylene flame gun and slides, the 8 linkage connecting rods are fixed to the hollow shaft, and the 8 high-temperature support sheets are arranged circumferentially. The hollow shaft of the variable diameter support device is slid to drive the 8 linkage connecting rods to expand, whereby the 8 high-temperature support sheets are expanded to the inner wall of the large carbon fiber resin-based composite component, and the expansion angle of the high-temperature support sheets changes in a timely manner with the diameter of the inner wall of the large carbon fiber resin-based composite component. The variable diameter support device is made of high-temperature alloy steel to meet ablation temperature requirements and provide stable flame ablation conditions for large variable diameter carbon fiber resin-based composite components.

The present invention is suitable for high-temperature ablation testing of large carbon fiber resin-based composite components. Large carbon fiber resin-based composite components generate a lot of smoke and harmful gases under extreme thermal environmental ablation, incurring hazards to an optical path of laser vibration measurement and the physical health of laboratory personnel. In the present invention, the smoke absorber is located on the left side of the high-temperature vibration box, and a square groove is formed on the left side of the high-temperature vibration box to match the external size of the smoke absorber. In extreme ablation situations, the transverse suction force of the smoke absorber effectively sucks out smoke and guides a flame ablation direction to a certain extent, thereby providing a safe, stable, and effective testing environment.

The present invention is suitable for simulating the real flight environments, ablation conditions, and airflow scouring of large carbon fiber resin-based composite components in ground environments, thereby effectively solving flame jet and flame velocity adjustment of the oxyacetylene flame gun. The vent valve described in the present invention is installed on the right side of the high-temperature vibration box. Inert gas such as argon is introduced through the vent valve, enabling a micro oxygen environment and reducing the generation of ablation smoke under the protection of gas.

The present invention is suitable for high-temperature vibration modal testing of large carbon fiber resin-based composite components. In the present invention, the laser vibrometer is fixedly installed at an intersection of the sliding truss I and the sliding truss II through bolts, and the sliding trusses move transversely and longitudinally on the sliding rail. According to vibration measuring point requirements, the trusses slide the laser vibrometer to a designated area for high-temperature vibration modal data collection.

The platinum rhodium thermocouple meets temperature measurement requirements above 1200° C., and passes through a flange on the right side of the high-temperature vibration box and the support body to connect the large carbon fiber resin-based composite component with a data collection instrument outside the high-temperature vibration box, so as to measure the temperature of the large carbon fiber resin-based composite component.

A Φ510 m circular groove is formed at a bottom of the high-temperature vibration box and closely matched with a top size of the vibration table to provide a vibration margin, and gaps around the circular groove are filled with insulation cotton.

The high-temperature fire door is formed in the front of the high-temperature vibration box for easy clamping of the large carbon fiber resin-based composite component.

A 300 mm×300 mm×50 mm square groove is formed on the left side of the high-temperature vibration box and tightly matched with an external size of the smoke absorber to absorb smoke generated by ablation.

A Φ60 m circular hole is formed on the right side of the high-temperature vibration box, and the oxyacetylene flame gun passes through the circular hole to provide a high-temperature ablation environment.

The 200 mm×30 mm×50 mm vibration measuring port is formed at the top of the high-temperature vibration box, and is made of 1200° C. tolerant fiber glass reinforced plastics.

The working principle of the present invention is as follows:

High-temperature bolts pass through the base of the support body and the base adapter plate to fix the support body to the top of the vibration table, the threaded ejection rod outside the conical fixture is rotated, the large carbon fiber resin-based composite component is bonded with a high-temperature adhesive and fixed into the conical fixture, and the vibration table applies random excitation to transmit vibration excitation signals to the large carbon fiber resin-based composite component. The oxyacetylene flame gun passes through the high-temperature vibration box and is fixed to one end of the large carbon fiber resin-based composite component, the hollow shaft of the variable diameter support device is slidably fixed to the outer wall of the oxyacetylene flame gun, and the other end of the variable diameter support device drives the linkage connecting rods to move by sliding the hollow shaft, whereby the high-temperature support sheets are expanded to the inner wall of the large carbon fiber resin-based composite component to provide a high-temperature ablative thermal environment above 1200° C. The platinum rhodium thermocouple passes through the flange on the right side of the high-temperature vibration box and the support body to connect the large carbon fiber resin-based composite component with the data collection instrument outside the high-temperature vibration box, so as to monitor temperature changes of the large carbon fiber resin-based composite component during ablation. Inert gas is introduced through the vent valve on the right side of the high-temperature vibration box to simulate a micro oxygen environment in a flight environment. The smoke absorber absorbs smoke generated by the ablation of the large carbon fiber resin-based composite component on the left side of the high-temperature vibration box and guides the flame ablation direction, to provide a safe and stable experimental environment. The laser vibrometer is fixedly installed on the support frame at the top of the high-temperature vibration box, the sliding trusses are slid to a vibration measuring point, and laser passes through the vibration measuring port and irradiates the large carbon fiber resin-based composite component to collect high-temperature vibration modal parameters. The present invention can simulate uneven ablation and micro oxygen environments of large carbon fiber resin-based composite components during flight in a safe and stable experimental environment on the ground, and achieve accurate testing of high-temperature ablation vibration modes of large carbon fiber resin-based composite components, thereby providing experimental means for the stability and design feasibility of large carbon fiber resin-based composite components in aerospace flight environments.

Compared with the prior art, the present invention has the following beneficial effects:

(1) Currently, the building of most high-temperature vibration mode testing devices employs radiation heating such as quartz lamps to form extreme high-temperature thermal environments, but the uniformly heated environments cannot accurately simulate uneven ablation during the flight of aircraft. Moreover, due to the limitation of melting points of materials such as quartz, heating devices such as quartz lamps cannot provide stable high-temperature thermal environments above 1400° C. Meanwhile, excitation devices such as vibrators cannot provide stable thrust for large carbon fiber resin-based composite components, affecting the stability of high-temperature thermal vibration modal data collection. In the present invention, the oxyacetylene flame gun passes through the interior of the high-temperature vibration box and moves to one end of the large carbon fiber resin-based composite component, and the variable diameter support device is fixed to the inner wall of the large carbon fiber resin-based composite component, thereby providing stable flame ablation conditions and overcoming the limitations of heating devices such as quartz lamps. The vibration table is fixedly connected to the support body through the high-temperature bolts, random excitation signals are applied by the vibration table and transmitted to the large carbon fiber resin-based composite component fixed by the support body, and laser from the laser vibrometer at the top of the high-temperature vibration box passes through the vibration measuring port to collect high-temperature vibration modal data. The present invention has the advantages of stably providing an uneven ablation environment above 1200° C., overcoming performance limitations of existing high-temperature thermal vibration devices, and achieving the collection of high-temperature vibration modal data from large carbon fiber resin-based composite components.

(2) The present invention is suitable for clamping large carbon fiber resin-based composite components with different outer diameters. The support body of the present invention is composed of the base, the support plate, the reinforcing ribs, and the conical fixture. Without damaging the integrity of the large carbon fiber resin-based composite component, the large carbon fiber resin-based composite component is nested and glued inside the conical fixture, and the threaded ejection rods distributed every 60° along the circumference of the conical fixture are rotated to adapt to the change in the outer diameter of the large carbon fiber resin-based composite component.

(3) The present invention is suitable for ablation testing of large carbon fiber resin-based composite components with different inner diameters. The variable diameter support device is used to adapt to the change in the inner diameter of the large carbon fiber resin-based composite component, and is composed of the hollow shaft, the linkage connecting rods, and the high-temperature support sheets, where the hollow shaft slides on the outer wall of the oxyacetylene flame gun and drives the linkage connecting rods to move and expand the high-temperature support sheets to the inner wall of the large carbon fiber resin-based composite component, and flame jet by the oxyacetylene flame gun passes through the variable diameter support device and gets close to the high-temperature support sheets to ablate the inner wall of the large carbon fiber resin-based composite component, thereby ensuring the stability of ablation.

(4) The present invention can provide a safe and stable experimental environment and simulate a micro oxygen flight environment. The vent valve is installed on the right side of the high-temperature vibration box, and inert gas such as argon is introduced to eliminate air inside the box, enabling a micro oxygen environment and reducing the generation of ablation smoke under the protection of gas. The smoke absorber is located on the left side of the high-temperature vibration box, and the square groove is formed on the left side of the high-temperature vibration box to match the external size of the smoke absorber. In extreme ablation situations, the transverse suction force of the smoke absorber effectively sucks out smoke and guides the flame ablation direction to a certain extent, thereby providing a safe, stable, and effective testing environment.

(5) The extreme ablation temperature affects the collection of vibration modal data by conventional acceleration sensors, and the acceleration sensors detach due to the winding of acceleration leads in the high-temperature vibration box. In the present invention, the laser vibrometer is arranged at the top of the high-temperature vibration box, and laser passes through the vibration measuring port of high-temperature fiber glass reinforced plastics and irradiates the outer surface of the large carbon fiber resin-based composite component to obtain high-temperature vibration modal parameters.

(6) High-temperature vibration modal data needs to be collected at a plurality of measuring points to meet vibration mode measuring point requirements. In the present invention, the sliding truss I and the sliding truss II are arranged at the top of the high-temperature vibration box, the laser vibrometer is fixedly installed on the trusses, and the sliding trusses slide transversely and longitudinally on the sliding rail according to the measuring point requirements, thereby achieving multi-point modal data collection of large carbon fiber resin-based composite components.

### BRIEF DESCRIPTION OF THE DRAWINGS

FIG. 1 is a front view of the present invention;

FIG. 2 is a rear view of the present invention;

FIG. 3 is a top view of the present invention;

FIG. 4 is a cross-sectional view of the present invention;

FIG. 5 is an enlarged view of a support body and a variable diameter support device of the present invention;

FIG. 6 is a side view of the support body and the variable diameter support device of the present invention; and

FIG. 7 is a combination diagram of the support body of the present invention.

### DETAILED DESCRIPTION OF THE EMBODIMENTS

The present invention will be further illustrated below in conjunction with the accompanying drawings and specific embodiments. It should be understood that the following specific embodiments are merely used for explaining the present invention, rather than limiting the scope of the present invention. It should be noted that the terms “front”, “back”, “left”, “right”, “upper”, and “lower” used in the following description refer to the directions in the accompanying drawings, and the terms “inside” and “outside” refer to the directions towards or away from the geometric center of a specific component respectively.

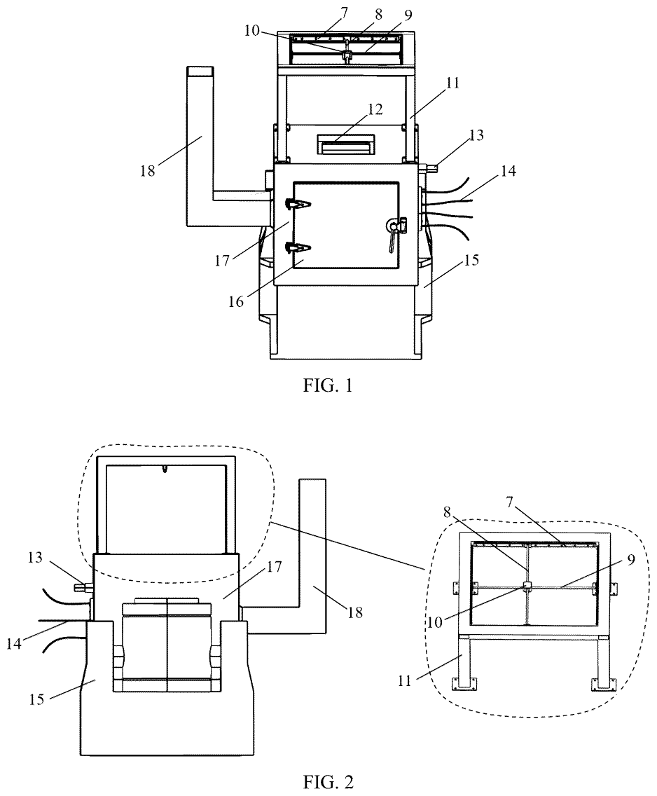

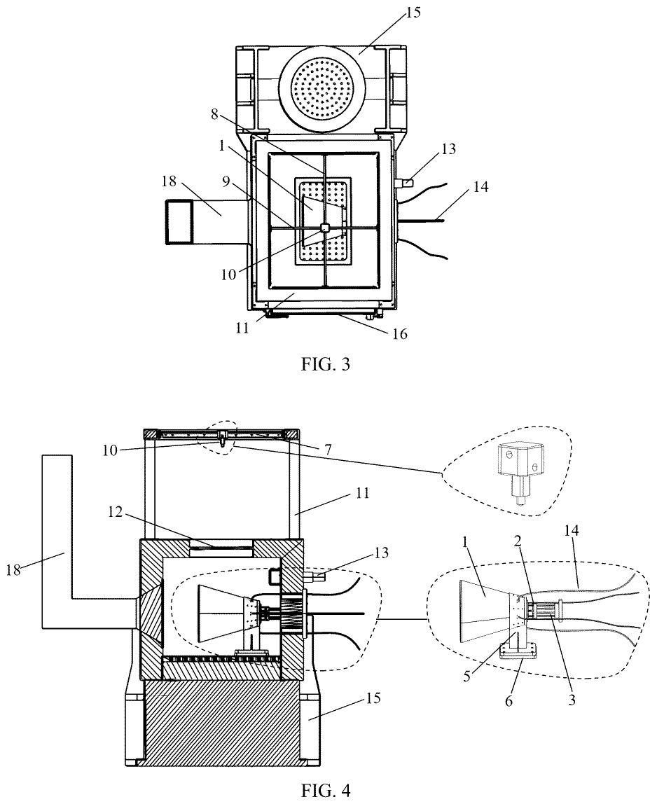

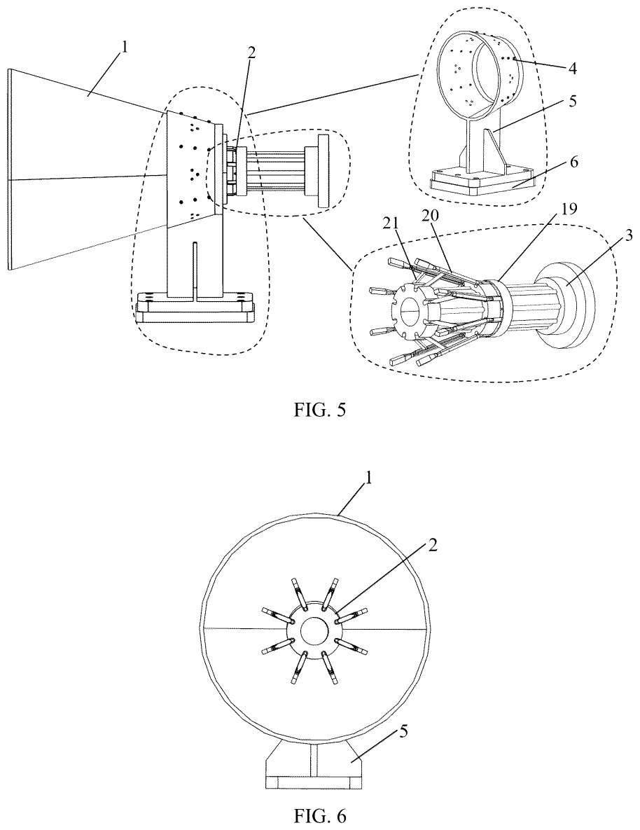

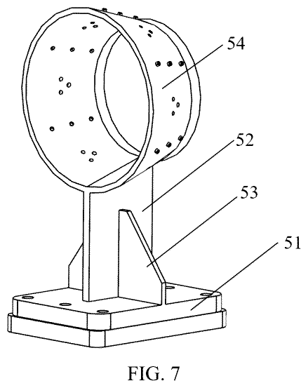

As shown in FIGS. 1, 2, 3, 4, 5, and 6, the present invention is composed of a large carbon fiber resin-based composite component 1, a variable diameter support device 2, an oxyacetylene flame gun 3, a threaded ejection rod 4, a support body 5, a base adapter plate 6, a sliding rail 7, a sliding truss I 8, a sliding truss II 9, a laser vibrometer 10, a support frame 11, a vibration measuring port 12, a vent valve 13, a platinum rhodium thermocouple 14, a vibration table 15, a high-temperature fire door 16, a high-temperature vibration box 17, a smoke absorber 18, a hollow shaft 19, high-temperature support sheets 20, and linkage connecting rods 21.

A base of the support body 5 and the base adapter plate 6 are fixed to a top of the vibration table through bolts, the threaded ejection rod 4 outside a conical fixture is rotated, the large carbon fiber resin-based composite component 1 is bonded with a high-temperature adhesive and fixed into the conical fixture of the support body 5, and the vibration table 15 applies random excitation to transmit vibration excitation signals to the large carbon fiber resin-based composite component 1. The oxyacetylene flame gun 3 passes through the high-temperature vibration box 17 and is fixed to one end of the large carbon fiber resin-based composite component 1, one end of the variable diameter support device 2 is slidably fixed to an outer wall of the oxyacetylene flame gun 3, and the other end of the variable diameter support device 2 drives the linkage connecting rods 21 to move by sliding the hollow shaft 19, whereby the high-temperature support sheets 20 are expanded to an inner wall of the large carbon fiber resin-based composite component 1 to provide a high-temperature ablative thermal environment above 1200° C. The high-temperature platinum rhodium thermocouple 14 passes through a flange on a right side of the high-temperature vibration box 17 and the support body 5 respectively to connect the large carbon fiber resin-based composite component 1 with a data collection instrument outside the high-temperature vibration box 17, so as to monitor temperature changes of the large carbon fiber resin-based composite component during ablation. Inert gas is introduced through the vent valve 13 on the right side of the high-temperature vibration box 17 to simulate a micro oxygen environment in a flight environment. The smoke absorber 18 absorbs smoke generated by the ablation of the large carbon fiber resin-based composite component 1 on a left side of the high-temperature vibration box 17 and guides a flame ablation direction, to provide a safe and stable experimental environment. The laser vibrometer 10 is fixedly installed on the support frame 11 at a top of the high-temperature vibration box 17. Laser passes through the vibration measuring port 12 and irradiates the large carbon fiber resin-based composite component 1 to collect high-temperature vibration modal parameters.

High-temperature vibration modal data needs to be collected at a plurality of measuring points to meet vibration mode measuring point requirements. In the present invention, transverse and longitudinal through holes are formed at the top and middle part of the laser vibrometer, the sliding truss I 8 is arranged at the top of the high-temperature vibration box and passes through the transverse through holes, the sliding truss II 9 passes through the longitudinal through holes, and the laser vibrometer is fixedly installed by the sliding truss I 8 and the sliding truss II 9. According to the measuring point requirements, the sliding truss I 8 and the sliding truss II 9 slide transversely and longitudinally on the sliding rail to reach a specified measuring point position, so as to complete modal data collection.

The technical means disclosed in the solutions of the present invention are not limited to the technical means disclosed in the foregoing embodiments, but also include technical solutions formed by any combination of the above technical features.

What is claimed is:

1. A high-temperature vibration device suitable for large carbon fiber resin matrix composite structural components, comprising a large carbon fiber resin matrix composite structural component, a variable diameter support device, an oxyacetylene flame gun, a threaded ejection rod, a support body, a base adapter plate, a laser vibrometer, a support frame, a vibration measuring port, a vent valve, a platinum rhodium thermocouple, a vibration table, a high-temperature fire door, a high-temperature vibration box, and a smoke absorber, wherein the high-temperature vibration box is provided on the vibration table; a sliding truss is provided at a top of the high-temperature vibration box; high-temperature bolts pass through the base adapter plate to fix the support body to a top of the vibration table, the large carbon fiber resin matrix composite structural component is fixed and nested inside the support body by the threaded ejection rod, the vibration table provides random excitation for the large carbon fiber resin matrix composite structural component, the platinum rhodium thermocouple passes through the support body and a surface of the large carbon fiber resin matrix composite structural component and is connected to an external data collection instrument, the oxyacetylene flame gun is fixed and nested inside the large carbon fiber resin matrix composite structural component by the variable diameter support device, inert gas is introduced through the vent valve on a right side of the high-temperature vibration box to simulate a micro oxygen environment in a high-temperature flight environment of the large carbon fiber resin matrix composite structural component, and a left side of the high-temperature vibration box is connected to the smoke absorber; and the smoke absorber absorbs smoke generated by ablation of the large carbon fiber resin matrix composite structural component, the vibration measuring port is formed at an upper end of the high-temperature vibration box, and laser from the laser vibrometer installed on the sliding truss penetrates the vibration measuring port and is projected onto an upper surface of the large carbon fiber resin matrix composite structural component to collect high-temperature vibration modal data of the large carbon fiber resin matrix composite structural component; and
the oxyacetylene flame gun is fixed to an end of the large carbon fiber resin matrix composite structural component, the variable diameter support device is nested on an outer wall of the oxyacetylene flame gun, and the variable diameter support device comprises a hollow shaft, eight linkage connecting rods, and eight high-temperature support sheets; the hollow shaft is nested on the outer wall of the oxyacetylene flame gun, the eight linkage connecting rods are fixed to the hollow shaft, and the eight high-temperature support sheets are arranged circumferentially on the eight linkage connecting rods; the hollow shaft slides on the outer wall of the oxyacetylene flame gun to drive the eight linkage connecting rods to move, whereby the eight high-temperature support sheets are expanded to an inner wall of the large carbon fiber resin matrix composite structural component; and a sliding distance of the hollow shaft is adjusted for flame ablation of the large carbon fiber resin matrix composite structural components with different diameters.

2. The high-temperature vibration device suitable for the large carbon fiber resin matrix composite structural components according to claim 1, wherein the support body comprises a base, a support plate, two reinforcing ribs, and a conical fixture; the base is provided with six threaded holes, and the high-temperature bolts pass through the base adapter plate to fix the base to the vibration table; and the support plate is welded to a middle part of the base, the two reinforcing ribs are distributed on both sides of the support plate, the conical fixture is welded to an upper end of the support plate, threaded ejection rod holes are formed every 60° along a circumference of the conical fixture, and the threaded ejection rod is rotated to fix the large carbon fiber resin matrix composite structural component inside the conical fixture.

3. The high-temperature vibration device suitable for the large carbon fiber resin matrix composite structural components according to claim 1, wherein a Φ510 m circular groove is formed at a bottom of the high-temperature vibration box and closely matched with a top size of the vibration table to provide a vibration margin; the high-temperature fire door is formed on a front side of the high-temperature vibration box; and a 300 mm×300 mm×50 mm square groove is formed on the left side of the high-temperature vibration box and closely matched with an external size of the smoke absorber.

4. The high-temperature vibration device suitable for the large carbon fiber resin matrix composite structural components according to claim 1, wherein a Φ60 mm circular hole is formed on the right side of the high-temperature vibration box, and the oxyacetylene flame gun passes through the Φ60 mm circular hole and is fixed to an end of the large carbon fiber resin matrix composite structural component to provide a high-temperature ablation environment; and the vibration measuring port of 200 mm×30 mm×50 mm is formed at the top of the high-temperature vibration box, and the vibration measuring port is made of 1200° C. tolerant fiber glass reinforced plastics.

5. The high-temperature vibration device suitable for the large carbon fiber resin matrix composite structural components according to claim 1, wherein the platinum rhodium thermocouple passes through a flange on the right side of the high-temperature vibration box and the support body to measure a temperature of the large carbon fiber resin matrix composite structural component.

6. The high-temperature vibration device suitable for the large carbon fiber resin matrix composite structural components according to claim 1, wherein the sliding truss is fixed to the top of the high-temperature vibration box, and the sliding truss comprises the support frame, a sliding rail, a first sliding truss, and a second sliding truss; and the first sliding truss and the second sliding truss pass through a top through hole and a middle through hole of the laser vibrometer respectively to be fixedly installed and slide transversely and longitudinally on the sliding rail.
